(19) United States
(12) Patent Application Publication
(10) Pub. No.: US 2012/0024137 A1
(43) Pub. Date: Feb. 2, 2012

(54) COMPOSITES AND BALLISTIC RESISTANT ARMOR ARTICLES CONTAINING THE COMPOSITES

(75) Inventor: MINSHON J. CHIOU, Chesterfield, VA (US)

(73) Assignee: E. I. DU PONT DE NEMOURS AND COMPANY, Wilmington, DE (US)

(21) Appl. No.: 12/847,144

(22) Filed: Jul. 30, 2010

(51) Int. Cl. F41H 5/04; B32B 5/12; F41H 5/08

(52) U.S. Cl. 89/36.02; 428/107; 89/904; 89/914; 89/915

(57) ABSTRACT

A composite useful in a ballistic resistant armor article comprises a first nonwoven layer comprising a first plurality of yarns the yarns comprising a first plurality of para-aramid filaments, the first plurality of yarns arranged parallel with each other and a second nonwoven layer comprising a second plurality of yarns comprising a second plurality of para-aramid filaments, the second plurality of yarns arranged parallel with each other. The first plurality of yarns of the first layer have an orientation in a direction that is different from the orientation of the second plurality of yarns in the second layer. The yarns have an elongation at break of 3.6 to 5.0 percent. The composite further comprises a thermoset or thermoplastic binding resin in the region of the interface between the two layers and a viscoelastic resin coating at least portions of external surfaces of the first and second pluralities of yarns.

### BACKGROUND OF THE INVENTION

1. Field of the Invention

This invention relates to composites and ballistic resistant armor articles containing the composites. The composites comprise layers of yarns of para-aramid filaments.

2. Description of Related Art

U.S. Pat. No. 6,990,886 to Citterio discloses an unfinished multilayer structure used to produce a finished multilayer anti-ballistic composite. The unfinished multilayer structure includes a first layer of threads parallel with each other, superimposed, with the interpositioning of a binding layer on at least a second layer of threads which are parallel with each other. The threads of the first layer are set in various directions with respect to the threads of the second layer. The two layers are also joined by binding threads made of a thermoplastic or thermosetting material or of a material which is water-soluble or soluble in a suitable solvent.

There is an ongoing need to provide multilayer structures of higher strength that will provide enhanced ballistic performance at similar or lower weight.

### BRIEF SUMMARY OF THE INVENTION

This invention is directed to a composite useful in a ballistic resistant armor article, comprising:

(a) from 75.0 to 96.0 weight percent of
a first nonwoven layer comprising a first plurality of yarns comprising a first plurality of para-aramid filaments, the first plurality of yarns arranged parallel with each other and
a second nonwoven layer comprising a second plurality of yarns comprising a second plurality of para-aramid filaments, the second plurality of yarns arranged parallel with each other,
the first plurality of yarns of the first layer having an orientation in a direction that is different from the orientation of the second plurality of yarns in the second layer, and
the first plurality and the second plurality of yarns have a yarn tenacity of 10 to 65 grams per dtex and an elongation at break of 3.6 to 5.0 percent.

(b), from 1.0 to 15.0 weight percent of a thermoset or thermoplastic binding resin coating at least portions of internal surfaces of the first plurality and the second plurality of yarns and filling some space between the filaments in the first plurality and the second plurality of yarns in the region of the interface between the two layers, and

(c) from 0.1 to 10.0 weight percent of a viscoelastic resin coating at least portions of external surfaces of the first plurality and the second plurality of yarns and filling some space between the filaments in the first plurality and the second plurality of yarns

wherein the weight percentages are expressed relative to the total weight of the composite.

The invention is further directed to a composite of the aforesaid character comprising four nonwoven layers wherein the yarns in any one layer have an orientation that is different from the yarns in an adjacent layer.

### BRIEF SUMMARY OF THE DRAWINGS

FIG. 1 shows a plan view in perspective of a composite used to produce a ballistic resistant armor article.

FIG. 2 shows a sectional view taken at 2-2 in FIG. 1.

FIG. 3 shows a sectional view of another embodiment comprising four nonwoven layers.

### DETAILED DESCRIPTION OF THE INVENTION

The present invention is directed to a composite useful in a ballistic resistant armor article. The composite comprises a plurality of nonwoven fibrous layers, a viscoelastic resin, a thermoset or thermoplastic resin and binding yarns.

### The Nonwoven Layers

In one embodiment the composite comprises two layers and in a further embodiment it comprises four layers.

The first nonwoven layer comprises a first plurality of first yarns. The first plurality of first yarns are arranged parallel with each other.

The second nonwoven layer comprises a second plurality of second yarns. The second plurality of second yarns are arranged parallel with each other.

The third nonwoven layer comprises a third plurality of third yarns. The third plurality of third yarns are arranged parallel with each other.

The fourth nonwoven layer comprises a fourth plurality of fourth yarns. The fourth plurality of fourth yarns are arranged parallel with each other.

The orientation of yarns in one layer of the composite is different from the orientation of yarns in an adjacent layer.

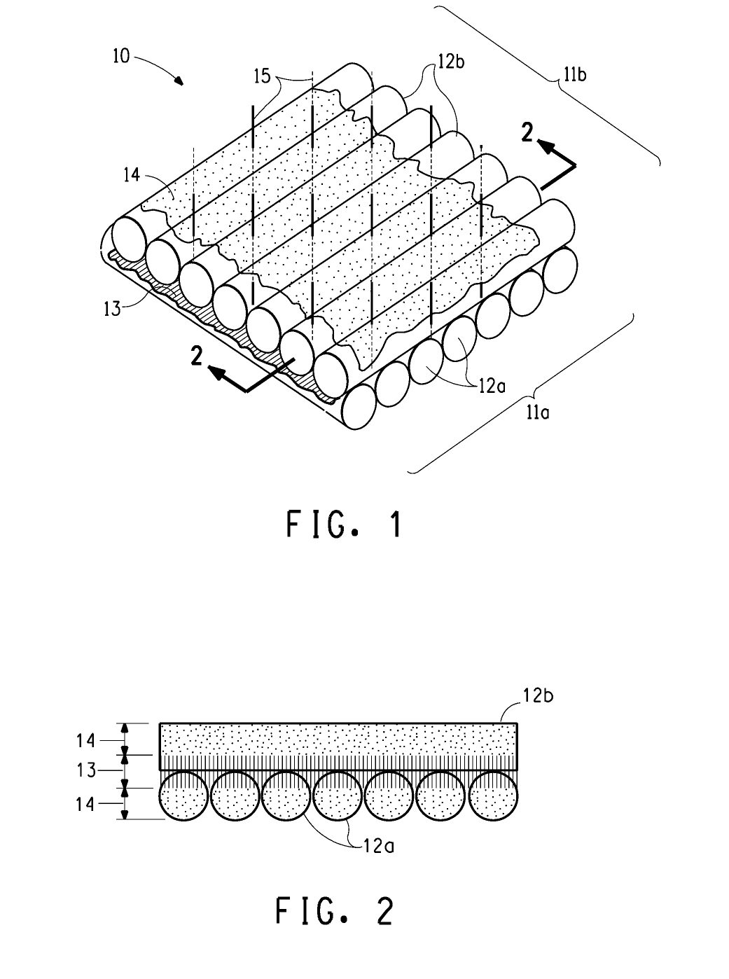

FIG. 1 shows generally at 10, a composite comprising two nonwoven layers 11a and 11b of reinforcement yarns 12a and 12b. The orientation of the first plurality of yarns 12a in the first layer 11a of the composite is different from the orientation of the second plurality of yarns 12b in the second layer 11b. As an example, the orientation of yarns in a first layer may be at zero degrees i.e. in the machine direction while the yarns in a second layer may be oriented at an angle of 90 degrees with respect to the orientation of yarns in the first layer. The machine direction is the long direction within the plane of the composite, that is, the direction in which the composite is produced. Examples of other orientation angles are +45 degrees and −45 degrees with respect to the machine direction. In a preferred embodiment the yarns in successive layers of the nonwoven composite are oriented at zero degrees and 90 degrees with respect to each other. In a four layer composite, the yarns may be oriented at angles of zero degrees, 90 degrees, zero degrees, 90 degrees respectively.

In a further embodiment the yarns in the first and second layers although being orthogonal to each other are arranged at an angle of +45 degrees and −45 degrees relative to the machine direction. Other embodiments include other cross ply angles between the yarns in adjacent layers. In some of these embodiments the yarns in adjacent layers need not be orthogonal to each other.

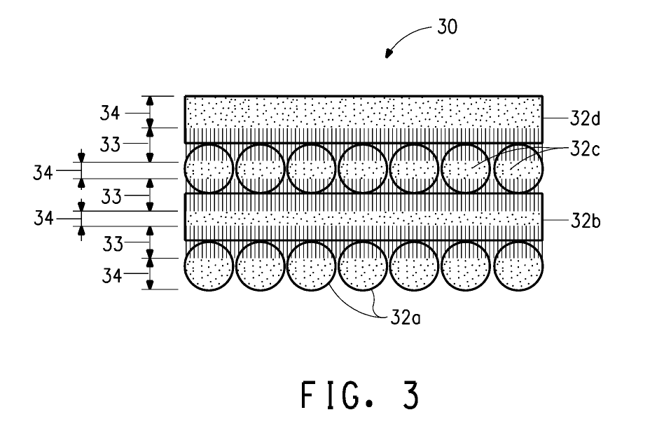

FIG. 3 shows generally at 30 a sectional view of a composite comprising four nonwoven layers of reinforcement yarns. The orientation of yarns 32a and 32c in the first and third layers respectively are in the same direction. The orientation of yarns 32b and 32d in the second and fourth layers respectively are in the same direction. The orientation of the yarns in the first and third layers is orthogonal to the orientation of yarns in the second and fourth layers.

### The Yarns

Each of the first yarns comprise a first plurality of first para-aramid filaments. Each of the second yarns comprise a second plurality of second para-aramid filaments. Each of the third yarns comprise a third plurality of third para-aramid filaments. Each of the fourth yarns comprise a fourth plurality of fourth para-aramid filaments.

The first, second, third and fourth yarns preferably have a yarn tenacity of from 10 to 65 grams per dtex and a modulus of from 400 to 3000 grams per dtex. Further, the yarns have a linear density of from 100 to 3,500 dtex and an elongation to break of from 3.6 to 5.0 percent. In one embodiment, the yarns have a linear density of from 300 to 1800 dtex and a tenacity of from 24 to 50 grams per dtex. In still some other embodiments, the yarns have a linear density of from 100 to 1200 dtex with a range of from 400 to 1000 dtex being especially useful. In a further embodiment, the yarns have an elongation to break of from 3.6 to 4.5 percent. A finished yarn may also be made by assembling or roving together two precursor yarns of lower linear density. For example two precursor yarns each having a linear density of 850 dtex can be assembled into a finished yarn having a linear density of 1700 dtex.

Each nonwoven layer has a basis weight of from 30 to 800 g/m². In some preferred embodiments the basis weight of each layer is from 45 to 500 g/m². In some other embodiments the basis weight of each layer is from 55 to 300 g/m². In yet some other embodiments, the layers of the composite all have the same nominal basis weight.

Untwisted yarns are preferred because they offer higher ballistic resistance than twisted yarns and because they spread to a wider aspect ratio than twisted yarns, enabling more consistent fiber coverage across the layer.

The layers comprise a plurality of yarns having a plurality of continuous filaments.

In one embodiment, the yarns used in the layers form a substantially flattened array of filaments wherein individual yarn bundles are difficult to detect. In such an embodiment, the filaments are uniformly arranged in the layer, meaning there is less than a 20 percent difference in the thickness of the flattened array. The filaments from one yarn shift and fit next to adjacent yarns, forming a continuous array of filaments across the layer.

In an alternative embodiment, the yarns can be positioned such that small gaps are present between the flattened yarn bundles, or the yarns may be positioned such that the yarn bundles butt up against other bundles, while retaining an obvious yarn structure. In other embodiments, the first and the second plurality of filaments are present in the first and the second plurality of layers as substantially distinct yarns.

It is believed the use of yarns having an elongation at break of from 3.6 to 5.0 percent allows for the use of thicker layers in the composite without an appreciable loss in ballistic performance. A composite comprising at least two nonwoven layers having a ratio of the thickness of any one layer to the equivalent diameter of the filaments comprising the layer of at least 13, in conjunction with the yarns comprising the layer having an elongation to break of from 3.6% to 5.0% and a tenacity of at least 24 grams per dtex, allows a finished article to be assembled with fewer layers and yet still meet performance requirements. This offers productivity and quality improvements in the assembly process.

In some embodiments of the composite, the ratio of the thickness of any layer to the equivalent diameter of the filaments comprising the layer is at least 13, more preferably at least 16 and most preferably at least 19. By “equivalent diameter” of a filament we mean the diameter of a circle having a cross-sectional area equal to the average cross-sectional area of the filaments comprising the layer. The ratio is calculated by first determining the thickness of a layer in the composite, typically by measuring the average thickness of the final composite and dividing by the number of layers, and then dividing by the equivalent diameter of a filament used in a layer. Typically, all of the layers are of the same basis weight and all of the layers have the same filaments. If resin is present between the successive yarn layers, the thickness of a layer is calculated by first determining the overall thickness of the composite and dividing that thickness by the number of yarn layers in the composite.

The yarns comprise from 75.0 to 96.0 weight percent based on the total weight of the composite.

### The Filaments

For purposes herein, the term “filament” is defined as a relatively flexible, macroscopically homogeneous body having a high ratio of length to width across its cross-sectional area perpendicular to its length. The filament cross section can be any shape, but is typically round or bean shaped. The yarns may also be round, bean shaped or oval in cross section. The filaments can be any length. Preferably the filaments are continuous. Multifilament yarn spun onto a bobbin in a package contains a plurality of continuous filaments.

The yarns of the present invention are made with filaments made from para-aramid polymer. As used herein, the term para-aramid filaments means filaments made of para-aramid polymer. The term aramid means a polyamide wherein at least 85% of the amide (—CONH—) linkages are attached directly to two aromatic rings. Suitable aramid fibers are described in Man-Made Fibres-Science and Technology, Volume 2, in the section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

The preferred para-aramid is poly (p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2, 6-naphthaloyl chloride or chloro- or dichloroterephthaloyl chloride or 3, 4′-diaminodiphenylether. In some preferred embodiments, the yarns of the composite consist solely of PPD-T filaments; in some preferred embodiments, the layers in the composite consist solely of PPD-T yarns; in other words, in some preferred embodiments all filaments in the composite are PPD-T filaments.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

### The Thermoset or Thermoplastic Binding Resin

The composite has a resin rich binding layer in the region of the interface between the respective layers. In a two layer composite the binder is in the interface region between the first nonwoven layer and the second nonwoven layer. In a three layer composite, the binder preferably is in the interface regions between the first nonwoven layer and the second nonwoven layer and between the second nonwoven layer and the third nonwoven layer. In a four layer composite, the binder preferably is in the interface regions between the first nonwoven layer and the second nonwoven layer, between the second nonwoven layer and the third nonwoven layer and between the third nonwoven layer and the fourth nonwoven layer. The binder resin layer is shown at 13 in FIGS. 1 and 2 and at 33 in FIG. 3. The binding layer does not fully impregnate into the yarn bundle but coats at least portions of the internal surfaces of the yarns in each layer in the interface region and fills some space between the filaments in each layer. The resin may be a thermoset or thermoplastic material. Suitable materials for the binding layer include polyolefinic films, thermoplastic elastomeric films, polyester films, polyamide films, polyurethane films and mixtures thereof. Useful polyolefinic films include low density polyethylene films, high density polyethylene films and linear low density polyethylene films. Preferably the binding layer is present in the composite in an amount from 1.0 to 15.0 weight percent based on the total weight of the composite.

The binding layer is applied by the steps of (i) forming a first nonwoven layer comprising a first plurality of yarns comprising a first plurality of para-aramid filaments, the first plurality of yarns arranged parallel with each other (ii) positioning the first surface of the resin binding layer on one surface of the first nonwoven layer (iii) forming a second nonwoven layer comprising a second plurality of yarns comprising a second plurality of para-aramid filaments, the second plurality of yarns arranged parallel with each other, (iv) positioning the second nonwoven layer onto the second surface of the resin binding layer and (v) repeating steps (i) to (iv) as required to add additional layers to the composite. The resin binding layer may be in a continuous form such as a film or in a discontinuous form such as a perforated film or a powder.

### The Viscoelastic Resin

The yarns of the outer surfaces of the two outer layers of the composite are coated with a resin solution comprising a viscoelastic resin and a solvent. The coating also fills some space between the filaments in the yarns in the region of the outer surfaces of the two outer nonwoven layers of the composite. This resin is shown at 14 in FIGS. 1 and 2 and at 34 in FIG. 3. The viscoelastic resin may be thermoplastic or thermoset. Suitable materials include polymers or resins in the form of a viscous or viscoelastic liquid. Preferred materials are polyolefins, in particular polyalpha-olefins or modified polyolefins, polyvinyl alcohol derivatives, polyisoprenes, polybutadienes, polybutenes, polyisobutylenes, polyesters, polyacrylates, polyamides, polysulfones, polysulfides, polyurethanes, polycarbonates, polyfluoro-carbons, silicones, glycols, liquid block copolymers, polystyrene-polybutadiene-polystyrene, ethylene co-polypropylene, polyacrylics, epoxies, phenolics and liquid rubbers. Preferred polyolefins are polyethylene and polypropylene. Preferred glycols are polypropylene glycol and polyethylene glycol. A preferred copolymer is polybutadiene-co-acrylonitrile. Polyisobutylene is a preferred resin. In a preferred embodiment, the resin coating does not fully impregnate the yarns. Preferably the visco-elastic resin is present in the composite in an amount from 0.1 to 10.0 weight percent and more preferably from 4.0 to 8.0 weight percent based on the total weight of the composite.

The solvent of the visco-elastic resin may be aliphatic, aromatic, cyclic or based on halogenated hydrocarbons. More preferably the solvent is non-polar. Suitable solvents include n-heptane and cyclohexane.

A typical process to coat or impregnate the yarns of the composite with visco-elastic resin comprises the steps of bringing the composite into contact with the resin. The resin can be in the form of a solution, emulsion, melt or film. When the resin is a solution, emulsion or melt, the composite can be immersed in the resin and surplus resin removed off with a doctor blade or coating roll. The resin may also be deposited onto the surface of the composite as it passes beneath a resin bath in a blade over roll coating process. The next step is to consolidate the resin impregnated composite by drying to remove the solvent or cooling to solidify the melt followed by a calendering step. The coated or impregnated composite is then rewound and cut for use in accordance with the present invention. When the visco-elastic resin is in the form of a film, the resin film is placed onto one or both surfaces of the composite and consolidated onto or into the composite by heat and pressure in a calender. The degree of resin impregnation into the fibers is controlled by the calendering conditions. The specific values for heat and pressure need to be determined for each material combination. Typically, the temperature is in the range of from 80 to 300 degrees C., preferably from 100 to 200 degrees C. and the pressure in the range of from 1 to 100 bar, preferably from 5 to 80 bar. The heat and pressure from this process also causes the binding layer resin to melt and flow to form the resin rich interface region between the respective layers of the composite. All the processes described here are well known to those skilled in the art and are further detailed in chapter 2.9 of “Manufacturing Processes for Advanced Composites” by F. C. Campbell, Elsevier, 2004.

### Binding Yarns

In some embodiments, binding threads or yarns may be present. These binding yarns, shown at 15 in FIG. 1, are stitched or knitted through the nonwoven layers of the composite in a direction orthogonal to the plane of the layers. This is also known as z-directional stitching. Any suitable binding yarn may be used with polyester fiber, polyethylene fiber, polyamide fiber, aramid fiber, polyareneazole fiber, polypyridazole fiber, polybenzazole fiber, and mixtures thereof being particularly suited. The spacing between rows of stitches may vary depending on design requirements. The stitches may be between yarns or through yarns. In one embodiment the rows are spaced 5 mm apart.

### Uses of the Composite

A ballistic resistant armor article can be produced by combining a plurality of composites as described in the above embodiments. This invention is applicable to both soft and hard body armor. Examples of soft armor include protective apparel such as vests or jackets that protect body parts from projectiles. Examples of hard armor include helmets and protective plates for vehicles. It is preferable that the composites are positioned in the article in such a way as to maintain the offset yarn alignment throughout the finished assembly. For example, the second composite of the article is placed on top of the first composite in such a way that the orientation of the yarns comprising the bottom layer of the second composite is offset with respect to the orientation of the yarns comprising the adjacent top layer of the first composite. The actual number of composites used will vary according to the design needs of each article being made. As an example, an assembly for an antiballistic vest pack typically has a total areal density of between 3.5 to 7.0 kg/m². Thus the number of composites will be selected to meet this weight target with the number typically being from 5 to 25. For hard armor vehicle plates the number of composites would be the amount required to form a cured pressed plate having a thickness of about 15 mm. For helmets, the cured plate thickness is from about 6 mm to 13 mm. Other components such as foam may also be incorporated into the armor article.

### Test Methods

The following test methods were used in the following Examples.

Linear Density: The linear density of a yarn or fiber was determined by weighing a known length of the yarn or fiber based on the procedures described in ASTM D1907-97 and D885-98. Decitex or “dtex” is defined as the weight, in grams, of 10,000 meters of the yarn or fiber. Denier (d) is 9/10 times the decitex (dtex).

Yarn Mechanical Properties: The yarns to be tested were conditioned and then tensile tested based on the procedures described in ASTM D885-98. Tenacity (breaking tenacity), modulus of elasticity and elongation to break were determined by breaking yarns on an Instron® universal test machine.

Areal Density: The areal density of a nonwoven layer was determined by measuring the weight of a 10 cm×10 cm sample of the layer. The areal density of the final article was the weight of a 10 cm×10 cm sample of the article.

Ballistic Penetration and Backface Deformation Performance: Ballistic tests of the multi-sheet panels were conducted in accordance with NIJ Standard-0101.04 “Ballistic Resistance of Personal Body Armor”, issued in September 2000 which defines capabilities for body armor for level IIIA protection. The armor must have a Backface Deformation (BFD) of no more than of 44 mm from a bullet at a velocity (Vₒ) defined as 1430 ft/sec plus or minus (+/−) 30 feet per sec (436 m/sec +/−9 m/sec). A second reported value is V50 which is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target. The reported values are average values for the number of shots fired for each example. 0.44 magnum and 9 mm bullets were used.

Layer Thickness and Equivalent Filament Diameter can be determined by standard electron microscopy techniques.

### EXAMPLES

The following examples are given to illustrate the invention and should not be interpreted as limiting it in any way. In all the Examples and Comparative Examples the nonwoven composite comprised first and second layers of para-aramid yarns aligned unidirectionally in an orthogonal configuration relative to each other and at +45°/−45° relative to the machine direction. The first yarn layer comprised a first plurality of yarns and the second yarn layer comprised a second plurality of yarns. A thermoplastic binding layer of polyurethane coated at least portions of the internal surfaces of the first plurality and the second plurality of yarns and filled some space between the filaments in the first plurality and the second plurality of yarns in the center region of the composite. Polyester threads of 140 denier were used for z-direction stitching through the plane of the first and second layers. The yarn used in the nonwoven fabric construction was 440 dtex Kevler® 129, available from E. I. du Pont de Nemours and Company, Wilmington, Del. The yarn had a nominal tenacity of 24.5 g/dtex. The nonwoven composite further comprised a viscoelastic resin of polyisobutene coating at least portions of external surfaces of the first plurality and the second plurality of yarns and filling some space between the filaments in the first plurality and the second plurality of yarns. The polyisobutene resin coated the first and second layers in regions remote from the interface of the two layers of the composite. The nonwoven composite had a nominal weight of 300 g/m².

### Comparative Example 1

Seventeen 380×380 mm sheets of non-woven composite made of Kevler® 129 yarn with a nominal tenacity of 24.5 g/dtex, an elongation-at-break of 3.4% and a modulus of 685 g/dtex were held together by stitches located at the four corners of the sheets (corner stitch). The corner stitching thread was Tex 70 spun Kevlar® available from Saunders Thread Company, Gastonia, N.C. A single layer of 3 mm thick polyethylene foam having an areal weight of 100 g/m² was placed at the back of the composite assembly, that is, the foam is facing away from the strike direction. The total weight of fabric plus foam was 5.2 kg/m². Ballistic testing was conducted using 0.44 magnum bullets against targets supported on a Roma Plastina number 1 clay backing medium. Results of the ballistic tests gave an average V50 value of 506 m/s and an average Back Face Deflection (BFD) value of 39 mm.

### Comparative Example 2

This example was made in a similar way to Comparative Example 1, except that ballistic testing was conducted using 9 mm bullets against targets supported on a Roma Plastina number 1 clay backing medium. The assembly of seventeen sheets of nonwoven composite plus one layer of PE foam had a total basis weight of 5.2 kg/m². Results of the ballistic tests gave an average V50 value of 535 m/s and an average Back Face Deflection value of 24 mm.

### Example 1

This example was made in a similar way to Comparative Example 1 except that the Kevlar® 129 yarn had a nominal tenacity of 24.5 g/dtex, an elongation-at-break of 3.85% and a modulus of 565 g/dtex. The assembly of seventeen sheets of nonwoven composite plus one layer of PE foam had a total basis weight of 5.2 kg/m². Results of the ballistic tests against 0.44 mag bullet gave an average V50 value of 528 m/s, which is about a 4.3% improvement when compared with Comparative Example 1. The average Back Face Deflection value was 37 mm.

### Example 2

This example was made in a similar way to Example 1, except that ballistic testing was conducted using 9 mm bullets against targets supported on a Roma Plastina number 1 clay backing medium. The assembly of seventeen sheets of nonwoven composite plus one layer of PE foam had a total basis weight of 5.2 kg/m². Results of the ballistic tests gave an average V50 value of 560 m/s, which is about a 4.7% improvement when compared with Comparative Example 2. The average Back Face Deflection value was 23 mm.

The results of the above Examples are summarized in Table 1.

TABLE 1

| | Areal Density | Bullet | | V50 | BFD |
|---|---|---|---|---|---|
| Reference | (kg/m2) | Type | | (m/s) | (mm) |
| Example 1 | 5.2 | .44 | mag | 528 | 37 |
| Example 2 | 5.2 | 9 | mm | 560 | 23 |
| Comparative Ex. A | 5.2 | .44 | mag | 506 | 39 |
| Comparative Ex. B | 5.2 | 9 | mm | 535 | 24 |

What is claimed is:

1. A composite useful in a ballistic resistant armor article, comprising:
(a) from 75.0 to 96.0 weight percent of
a first nonwoven layer comprising a first plurality of yarns comprising a first plurality of para-aramid filaments, the first plurality of yarns arranged parallel with each other and
a second nonwoven layer comprising a second plurality of yarns comprising a second plurality of para-aramid filaments, the second plurality of yarns arranged parallel with each other,
the first plurality of yarns of the first layer have an orientation in a direction that is different from the orientation of the second plurality of yarns in the second layer, and
the first plurality and the second plurality of yarns have a yarn tenacity of 10 to 65 grams per dtex and an elongation at break of 3.6 to 5.0 percent.
(b) from 1.0 to 15.0 weight percent of a thermoset or thermoplastic binding resin coating at least portions of internal surfaces of the first plurality and the second plurality of yarns and filling some space between the filaments in the first plurality and the second plurality of yarns in the region of the interface between the two layers, and
(c) from 0.1 to 10.0 weight percent of a viscoelastic resin coating at least portions of external surfaces of the first plurality and the second plurality of yarns and filling some space between the filaments in the first plurality and the second plurality of yarns
wherein the weight percentages are expressed relative to the total weight of the composite.

2. The composite of claim 1, wherein a ratio of a maximum thickness of the first or second layer to an equivalent diameter of the filaments in the first or second layer, respectively, is at least 13.

3. The composite of claim 1, wherein the second plurality of yarns in the second layer are oriented orthogonally to the first plurality of yarns in the first layer.

4. The composite of claim 1, wherein the first and the second plurality of filaments are present in the first and the second plurality of layers as substantially distinct yarns.

5. The composite of claim 1, wherein the viscoelastic resin is polyolefin, polyvinyl alcohol, polyisoprene, polybutadiene, polybutene, polyisobutylene, polyester, polyacrylate, polyamide, polysulfone, polysulfide; polyurethane, polycarbonate, polyfluorocarbon, silicone, glycol, liquid block copolymer, polyacrylic, epoxy, phenolic, liquid rubber or mixtures thereof.

6. The composite of claim 6, wherein the viscoelastic resin is polybutene or polyisobutylene.

7. The composite of claim 1, wherein the first and second plurality of yarns of the first and second layers, respectively, have a tenacity of 20 to 40 grams per dtex.

8. The composite of claim 1, wherein the first and second plurality of yarns of the first and second layers, respectively, have an elongation at break of 3.6 to 4.5 percent.

9. The composite of claim 1, wherein the modulus of elasticity of the first and second plurality of yarns is from 100 to 3500 grams per dtex.

10. The composite of claim 1, wherein the thermoplastic binding resin is polyurethane.

11. The composite of claim 1, further comprising at least one binding yarn binding the first and second layers together.

12. The composite of claim 11, wherein the at least one binding yarn comprises a plurality of filaments wherein the filaments are polyester filaments, polyethylene filaments, polyamide filaments, aramid filaments, polyareneazole filaments, polypyridazole filaments, polybenzazole filaments, or mixtures thereof.

13. A composite useful in a ballistic resistant armor article, comprising:
(a) from 75.0 to 96.0 weight percent of
a first nonwoven layer comprising a first plurality of yarns comprising a first plurality of para-aramid filaments, the first plurality of yarns arranged parallel with each other,
a second nonwoven layer comprising a second plurality of yarns comprising a second plurality of para-aramid filaments, the second plurality of yarns arranged parallel with each other,
a third nonwoven layer comprising a third plurality of yarns comprising a third plurality of para-aramid filaments, the third plurality of yarns arranged parallel with each other,
a fourth nonwoven layer comprising a fourth plurality of yarns comprising a fourth plurality of para-aramid filaments, the fourth plurality of yarns arranged parallel with each other,
the second plurality of yarns of the second layer having an orientation in a direction that is different from the orientation of the first plurality of yarns in the first layer and the third plurality of yarns in the third layer,
the fourth plurality of yarns of the fourth layer having an orientation in a direction that is different from the orientation of the third plurality of yarns in the third layer and
the first, second, third and fourth pluralities of yarns have a yarn tenacity of 10 to 65 grams per dtex and an elongation at break of 3.6 to 5.0 percent.
(b) from 1.0 to 15.0 weight percent of a thermoset or thermoplastic binding resin coating at least portions of internal surfaces of the first, second, third and fourth pluralities of yarns and filling some space between the filaments of the first, second, third and fourth pluralities of yarns in the region of the interfaces between the yarn layers, and
(c) from 0.1 to 10.0 weight percent of a viscoelastic resin coating at least portions of external surfaces of the first plurality and the fourth plurality of yarns and filling some space between the filaments in the first plurality and the fourth plurality of yarns
wherein the weight percentages are expressed relative to the total weight of the composite.

14. A ballistic resistant armor article, comprising a plurality of the composites of claim 1 or claim 13.

15. The article of claim 14 which comprises hard or soft body armor.
